(19) United States
(12) Patent Application Publication
(10) Pub. No.: US 2021/0330550 A1
(43) Pub. Date: Oct. 28, 2021

(54) Hot Stone Placement Pad Systems and Methods

(71) Applicant: Jacqueline Bell, San Diego, CA (US)

(72) Inventor: Jacqueline Bell, San Diego, CA (US)

(21) Appl. No.: 17/238,230

(22) Filed: Apr. 23, 2021

Related U.S. Application Data
(60) Provisional application No. 63/014,614, filed on Apr. 23, 2020.

(51) Int. Cl. A61H 39/04; A61H 39/06

(52) U.S. Cl. CPC A61H 39/04; A61H 2201/1654; A61H 2201/0207; A61H 39/06

(57) ABSTRACT

A hot stone placement pad includes a number of retaining pockets, each configured to hold a corresponding stone during a session, wherein substantially all of the retaining pockets face inward toward the central axis of the pad such that the pad may be grasped at opposite ends and lifted from the client's body while the stones remain in their respective pockets. The dimensions of the pad and the positions of the retaining pockets may be scaled to the client's body size.

### CROSS-REFERENCE TO RELATED APPLICATIONS

This application claims priority to U.S. Provisional Patent Application No. 63/014,614, filed Apr. 23, 2020, the entire contents of which are incorporated by reference.

### TECHNICAL FIELD

The present invention relates, generally, to hot stone therapy and, more particularly, to placement pads used in connection with such therapy

### BACKGROUND

Hot stone therapy is a technique in which hot, smooth stones (e.g., volcanic basalt stones) are placed on a patient's body at carefully chosen locations and/or are used to massage the client's body. The deep, penetrating heat tends to restore the emotional, physical, and spiritual well-being of the individual. More particularly, hot stone therapy has a beneficial effect with respect to muscle relaxation, blood and lymph circulation, relief from minor aches and pains, and stress-reduction. In addition, related techniques such as cold-stone therapy and “contrast” therapy (involving cycling between cold and hot modes) may also be employed to achieve desirable results.

Currently known systems and methods for hot stone therapy are unsatisfactory in a number of respects. For example, a typical hot stone therapy session begins by placing a cloth pad on the client's body, and then positioning the hot stones one-by-one at specific locations on the pad. As will be appreciated, it is possible for the stones to move or even roll off of the pad when the client moves abruptly. Similarly, at the end of the session, the process of removing the stones one-by-one from the pad is tedious, time-consuming, and can lead to inadvertent dropping of stones.

In addition, since the top surfaces of the stones are exposed to the ambient environment during therapy, the temperature of the stones tends to drop very quickly due to free convection heat transfer effects.

Systems and methods are therefore needed that overcome these and other limitations of the prior art.

### SUMMARY OF THE INVENTION

Various embodiments of the present invention relate to systems and methods for, inter alia: i) a hot stone placement pad that includes a number of retaining pockets, each configured to hold a corresponding stone during a session; ii) a hot stone placement pad as above, wherein substantially all of the retaining pockets face inward—i.e., toward the central axis of the pad—such that the pad may be grasped at opposite ends and lifted from the client's body while the stones remain in their respective pockets; and iii) hot stone placement pads as above, where the dimensions of the pad and the positions of the retaining pockets are scaled to the client's body size.

### BRIEF DESCRIPTION OF THE DRAWING FIGURES

The present invention will hereinafter be described in conjunction with the appended drawing figures, wherein like numerals denote like elements, and:

FIG. 1 is a conceptual overview of a 16-pocket placement pad configuration in accordance with various embodiments;

FIG. 2 illustrates the use of the placement pad of FIG. 1 in connection with a patient;

FIG. 3 illustrates the placement pad of FIG. 2 being removed from a patient; and

FIG. 4 illustrates a 12-pocket placement pad configuration in accordance with a smaller, alternate embodiment.

### DETAILED DESCRIPTION OF PREFERRED EXEMPLARY EMBODIMENTS

The present subject matter generally relates to an improved hot stone placement pad design. In accordance with various embodiments, the hot stone placement pad includes a number of retaining pockets (for example, 12-16 pockets), each configured to hold a corresponding stone during a session. All or substantially all of the retaining pockets face inward toward the center of the pad. In this way, the pad may be grasped at opposite ends and lifted from the client's body in one motion while the stones remain in their respective pockets. Furthermore, the pockets tend to help insulate the stones and protect their top surfaces from heat loss.

As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to hot stone therapy, massage techniques, and fabric construction may not be described in detail herein.

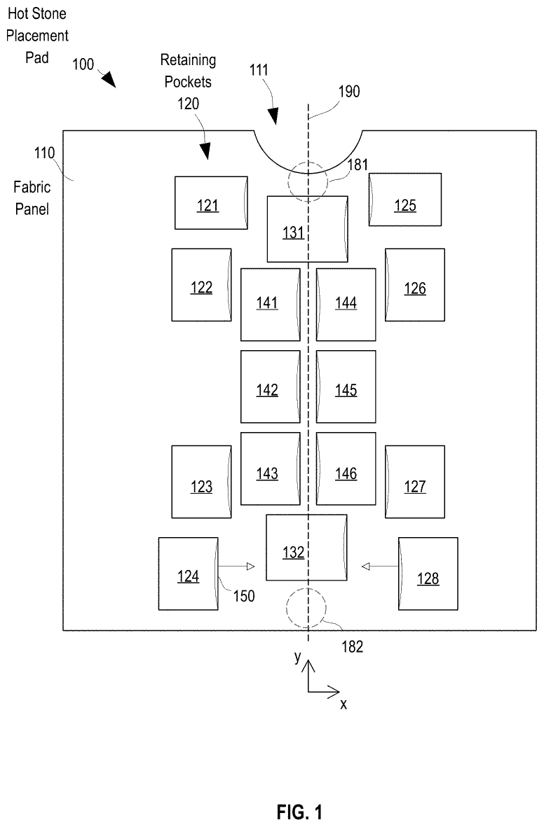

Referring first to FIG. 1, a hot stone placement pad (or simply “pad”) 100 in accordance with one embodiment includes a fabric panel (or simply “panel”) 110, to which a number of retaining pockets (or simply “pockets”) 120 have been sewn or otherwise attached. Panel 110 has a central axis 190 (which, during a session, will be substantially aligned with the client's spine) and includes a generally semicircular cut-out region 111 along one edge for accommodating the location of the client's neck and head region. In this regard, the term “client” refers to a human being that is undergoing the hot stone therapy.

In the illustrated embodiment, pad 100 includes sixteen total pockets 120 (i.e., pockets, 121-128, 131-132, and 141-146) arranged such that they exhibit reflectional symmetry about axis 190. As discussed in further detail below, however, the example shown in FIG. 1 is not intended to be limiting; the pad may include any number of retaining pockets 120 positioned in any desired configuration to match, for example, certain anatomical features of a client.

In the embodiment shown in FIG. 1, the pockets are configured as follows: pockets 141-146 are placed on opposite sides of the client's spine adjacent to the erector spinae muscles; pocket 131 generally corresponds to the C7 vertebrae; pocket 132 generally corresponds to the sacrum; pockets 121 and 125 correspond to the top shoulders; pockets 122 and 126 correspond to the scapula regions; pockets 123 and 127 correspond to the quadralatus lumborum; and pockets 124 and 128 correspond to the gluteus maximus.

A variety of hot stone weights may be used, with heavier stones being used for some regions, and lighter stones used for others. Using the standard nomenclature of “heavy”, “medium”, and “small” stones, heavy stones may be used in pockets 131, 132, 123, 127, 124, 128; medium stones may be used in pockets 121, 125, 122, and 126; and small stones may be used in pockets 141-146. This configuration results in a total weight over the back of approximately 8 to 10 pounds. The invention is not limited to particular weights and sizes of stones, however.

Panel 110 may be fabricated using a variety of materials. For example, in one embodiment, panel 110 is manufactured using a soft, bamboo textile material. In other embodiments, panel 110 is fabricated using alpaca, hemp, cotton, silk, wool, linen, and/or synthetic fibers.

As illustrated in FIG. 1, each pocket 120 includes a small fabric component (comprising, for example, any of the materials cited above with respect to panel 110) sewn to panel 110 such that an opening is provided for inserting and removing an individual stone (e.g., opening 150 of pocket 124). In the illustrated embodiment, for example, each pocket is rectangular and is attached to panel 110 on three sides, leaving the fourth side open. It will be appreciated that pockets 120 need not be strictly rectangular, and may be any shape suitable for holding an individual stone (e.g., semicircular, curvilinear, or the like).

The openings of each pocket 120 are preferably oriented such that they face “inward”—i.e., toward the central axis 190. This can be seen, for example, with pockets 124 and 128, each of which has an opening direction (indicated by respective arrows) substantially perpendicular to axis 190 and facing inward as shown (e.g., pockets 121-128 and 141-146). For some pockets that lie more or less directly on central axis 190 (e.g., pockets 131 and 132), the opening may be placed so that it faces one side (i.e., parallel to the x-axis) or faces toward the top or bottom of panel 110 (i.e., parallel to the y-axis).

The size of each pocket 120 may vary, but in one embodiment they are approximately 3.5″ to 4″ along one dimension, and about 3″ to 3.5 inch along one dimension. In accordance with one particular embodiment, hot stone placement pad 100 has the same relative dimensions as that shown in FIG. 1, with the total x dimension (width) of pad 100 being about 25 inches, and a y dimension (height) of about 25 inches. These dimensions are not intended to be limiting.

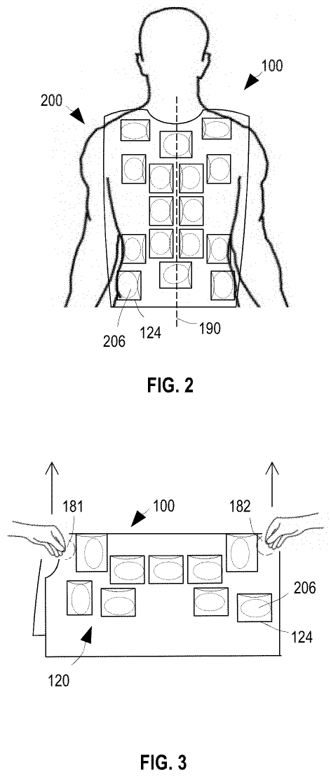

FIG. 2 illustrates pad 100 positioned over the back region of a client 200, with central axis 190 substantially aligned with the client's spine, and the semicircular opening (111 in FIG. 1) positioned near the neck region of the client. Hot stones are illustrated as being secured within their respective pockets. For example, a stone 206 is illustrated within pocket 124.

In accordance with one aspect of the present invention, the therapist may, when the hot stone therapy session is complete, quickly lift the pad 100 upward by and away from the client's body by grasping opposite sides of pad 100 (e.g., points or regions 181 and 182 in FIG. 1). This is illustrated in FIG. 3, which shows pad 100 being lifted upward while being grasped at regions 181 and 182. For example, pad 100 can be grabbed by the pockets (131 and 132) with the thumb on top of the stone and two fingers under the stone such that the stones are secured with support in the middle. This causes the two halves of pad 100 to fold back in such a way that the stones—by virtue of the pocket opening orientation—are retained within their respective pockets. As will be appreciated, this functionality provides a great benefit with respect to convenience and safety, particularly with respect to traditional methods, which require each stone to be removed one-by-one from the client's body.

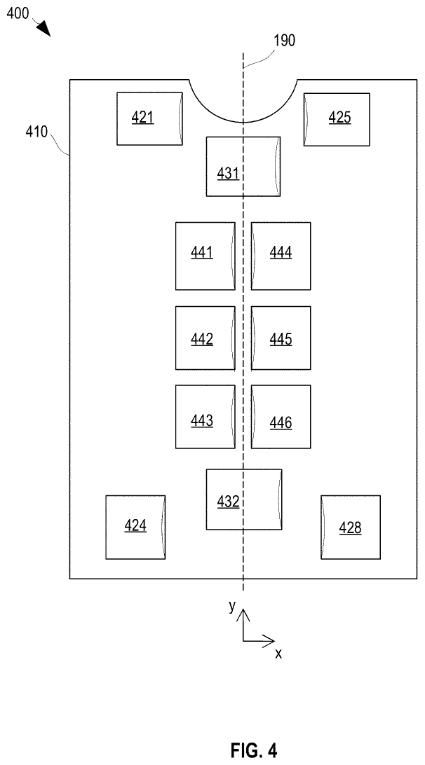

As mentioned above, the hot stone placement pad may be provided in a number of sizes and with any number of retaining pockets. FIG. 4, for example, illustrates a smaller pad 400 with a panel 410 that includes only twelve retaining pockets (i.e., pockets 421, 424-425, 428, 431-432, and 441-446). In this embodiment, pockets 431 and 432 are positioned collinear with the client's spine, pockets 441-446 are symmetrically positioned adjacent to and on opposite sides of the client's spine, pockets 424 and 428 are positioned adjacent to the client's glute regions, and pockets 421 and 425 are positioned adjacent to the client's scapula regions.

In summary, what has been provided is an advanced hot stone placement pad with a variety of beneficial features. In this regard, while the present embodiments have been described in the context of a pad deployed on a client's back, the present invention may be used in connection with a variety of anatomical applications. Such applications include, for example, a leg and feet pad, a décolleté pad, or a small, 6-pocket pad for use by chiropractors. Furthermore, the present invention may also be used in connection with cold stone therapy and “contrast” therapy involving both hot and cold stones.

Those skilled in the art will appreciate that embodiments of the present disclosure may be practiced in conjunction with any number of systems, and that the systems described herein are merely exemplary embodiments of the present disclosure. Further, the various components and connecting lines shown in the various figures contained herein are intended to represent example functional relationships and/or physical couplings between the various elements. It should be noted that many alternative or additional functional relationships or physical connections may be present in an embodiment of the present disclosure.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A hot stone therapy pad comprising:
a fabric panel having a first surface, a second surface, and a central axis; and
a plurality of retaining pockets provided on the first side of the fabric panel for holding corresponding hot stones, each of the retaining pockets having an opening;
wherein the opening of each of the retaining pockets faces inward toward the central axis.

2. The hot stone therapy pad of claim 1, wherein the fabric panel comprises an organic material selected from the group consisting of bamboo, alpaca, and hemp.

3. The hot stone therapy pad of claim 1, wherein the fabric panel has a generally semicircular cutout lying along the central axis on one edge of the fabric panel for accommodating the neck region of a client.

4. The hot stone therapy pad of claim 1, wherein the plurality of retaining pockets comprises 10-16 retaining pockets positioned symmetrically with respect to the central axis.

5. The hot stone therapy pad of claim 4, wherein the plurality of retaining pockets includes: approximately six pockets corresponding to opposite sides of the spine adjacent to the erector spinae muscles; one pocket generally corresponding to the C7 vertebrae; one pocket generally corresponding to the sacrum; two pockets correspond to the top shoulders; two pockets corresponding to the scapula regions; two pockets corresponding to the quadralatus lumborum; and two pockets corresponding to the gluteus maximus.

6. A method of providing hot stone therapy using a hot stone therapy pad as described in claim 1.

7. A hot stone therapy kit comprising: a hot stone therapy pad as described in claim 1 and a plurality of stones configured to fit within the retaining pockets of the therapy pad.

8. A method of providing hot stone therapy to a client, the method comprising:
providing a fabric panel having a first surface, a second surface, a central axis, and a plurality of retaining pockets provided on the first side of the fabric panel for holding corresponding hot stones, each of the retaining pockets having an opening facing inward toward the central axis;
placing the fabric panel on a surface of the client;
heating a plurality of stones; and
placing the plurality of stones in respective retaining pockets of the fabric panel.

9. The method of claim 8, wherein the fabric panel comprises an organic material selected from the group consisting of bamboo, alpaca, and hemp.

10. The method of claim 8, wherein the fabric panel has a generally semicircular cutout lying along the central axis on one edge of the fabric panel for accommodating the neck region of a client.

11. The method of claim 8, wherein the plurality of retaining pockets comprises 10-16 retaining pockets positioned symmetrically with respect to the central axis.

12. The method of claim 11, wherein the plurality of retaining pockets includes: approximately six pockets corresponding to opposite sides of the spine adjacent to the erector spinae muscles; one pocket generally corresponding to the C7 vertebrae; one pocket generally corresponding to the sacrum; two pockets correspond to the top shoulders; two pockets corresponding to the scapula regions; two pockets corresponding to the quadralatus lumborum; and two pockets corresponding to the gluteus maximus.

13. A hot stone therapy kit comprising:
a fabric panel having a first surface, a second surface, a central axis, and a plurality of retaining pockets provided on the first side of the fabric panel for holding corresponding hot stones, each of the retaining pockets having an opening facing inward toward the central axis;
a plurality of stones configured to fit within the retaining pockets of the therapy pad.

14. The hot stone therapy kit of claim 13, wherein the fabric panel has a generally semicircular cutout lying along the central axis on one edge of the fabric panel for accommodating the neck region of a client.

15. The hot stone therapy kit of claim 13, wherein the plurality of retaining pockets comprises 10-16 retaining pockets positioned symmetrically with respect to the central axis.

16. The hot stone therapy kit of claim 13, wherein the plurality of retaining pockets includes: approximately six pockets corresponding to opposite sides of the spine adjacent to the erector spinae muscles; one pocket generally corresponding to the C7 vertebrae; one pocket generally corresponding to the sacrum; two pockets correspond to the top shoulders; two pockets corresponding to the scapula regions; two pockets corresponding to the quadralatus lumborum; and two pockets corresponding to the gluteus maximus.
